(19) United States
(12) Patent Application Publication
(10) Pub. No.: US 2019/0263287 A1
(43) Pub. Date: Aug. 29, 2019

(54) Charging Station, Electric Vehicle and System Comprising a Charging Station and an Electric Vehicle

(71) Applicants: Jürgen Waffner, Essen (DE); Stephan Voit, Essen (DE)

(72) Inventors: Jürgen Waffner, Essen (DE); Stephan Voit, Essen (DE)

(73) Assignee: innogy SE, Essen (DE)

(21) Appl. No.: 16/409,286

(22) Filed: May 10, 2019

Related U.S. Application Data
(63) Continuation of application No. PCT/EP2017/073294, filed on Sep. 15, 2017.

(30) Foreign Application Priority Data
Nov. 11, 2016 (DE) 10 2016 121 628.3

(51) Int. Cl. B60L 53/66; H02J 7/02; B60L 53/12; B60L 53/62; B60L 53/30; B60L 55/00; B60L 50/60

(52) U.S. Cl. CPC B60L 53/665; H02J 7/025; B60L 53/12; B60L 53/62; B60L 53/30; B60Y 2300/91; B60L 50/60; B60L 2210/20; B60L 2210/40; B60Y 2200/91; B60L 55/00

(57) ABSTRACT

Charging station for electric vehicles with an induction coil arranged for inductive coupling with an induction coil of an electric vehicle, a grid connection point arranged for connection to an electrical grid, a meter arranged to obtain an electrical power flow from the induction coil to the grid connection point, and a processor. In order that an inductive feedback from an energy storage of an electric vehicle can take place in a grid compatible manner, it is provided that the processor generates at least one synchronization signal for the electric vehicle coupled to the induction coil for synchronization of the input voltage at the induction coil with a grid frequency at the grid connection point. Also provided are an electric vehicle and a corresponding system.

### CROSS-REFERENCE TO RELATED PATENT APPLICATIONS

This patent application is a continuation of PCT/EP2017/073294, filed Sep. 15, 2017, which claims priority to German Application No. 10 2016 121 628.3, filed Nov. 11, 2016, the entire teachings and disclosure of which are incorporated herein by reference thereto.

### FIELD

The subject matter relates to a charging station for electric vehicles, an electric vehicle and a corresponding system.

### BACKGROUND

Charging stations for electric vehicles as well as electric vehicles are well known. Electric vehicles in the sense of the subject-matter can be, for example, passenger cars (cars) or trucks (lorries), which are equipped with an electric energy storage and are at least partially driven by an electric motor. Electric two-wheeled vehicles can also be electric vehicles in the sense of the subject-matter. What all electric vehicles have in common is that they have an internal energy storage for supplying energy to the electric drive motor. Since the drive motor is operated with the help of the energy storage, it is usually sufficiently large, for example it has a storage capacity of 5 kWh, 20 kWh or even 100 kWh and more. It has been recognised that energy storage systems can also be used for grid stabilisation or as intermediate storage systems for private electrical generation plants. In this case it is necessary to be able to feed the electrical energy back from the energy storage into the electrical power supply network.

In addition to connecting electric vehicles via a charging cable, it is also possible to electrically connect electric vehicles to a charging station by means of electromagnetic coupling, in particular induction. For this purpose, an induction coil is arranged both in the electric vehicle and at the charging station, which are magnetically coupled to each other when spatially arranged correctly. This allows electrical energy to be exchanged between the two coils.

For feeding back power it is necessary that electrical energy from the energy storage of the electric vehicle is fed into the induction coil of the charging station via the induction coil arranged in the electric vehicle. However, this feedback is not unproblematic, especially when connecting to the electric grid, since the grid stability must also be guaranteed during feedback.

For this reason, the subject-matter was based on the object of providing a charging station for electric vehicles, in which an inductive feedback from an energy storage of an electric vehicle can take place in a grid-compatible manner.

### BRIEF SUMMARY

This object is solved by a charging station, an electric vehicle and a system according to the present disclosure.

It has been recognised that the supply quality of the grid must not be impaired when feeding back electrical energy into the grid. In particular, the mains frequency of the grid must always be maintained within narrow frequency limits. In order to make this possible, it is necessary for the energy stored in the electric vehicle to be fed back synchronously with the mains frequency. According to the subject-matter, the charging station has an induction coil which is set up for inductive coupling with an induction coil of an electric vehicle. An induction coil of this type can be located in or on the charging station, for example on the ground side, in the vicinity of a kerbstone, on the housing of the charging station or otherwise near the charging station.

Preferably, the induction coil of the charging station is set up exclusively for feeding back from an energy storage of an electric vehicle and is not used to feed electrical energy from the grid inductively into the electric vehicle. Therefore, the induction coil is preferably such that electrical power flows only from the induction coil towards the grid, but not from the grid into the induction coil. Suitable circuit measures, such as diodes, can be used for this purpose.

The charging station is also connected to a grid via a grid connection point. A grid connection point is preferably a single-phase or three-phase connection point at preferably a low-voltage or medium-voltage grid. The induction coil is connected via the mains connection with at least one power circuit breaker, one residual current circuit breaker and/or one control electronics connected in between.

A meter is also located in the charging station according to the subject-matter. The meter is arranged to measure an electrical power flow from the induction coil to the mains connection point. So-called smart meters, which can measure at least the current and voltage to detect an electrical power, are particularly suitable for this purpose. In addition, a phase position, a mains frequency and other relevant electrical quantities can also be recorded in the meter.

Finally, a processor is arranged in the charging station, which can either be integrated in the meter or can also be arranged outside the meter as part of the charging electronics.

For grid synchronous feedback from the energy storage of the electric vehicle, it is necessary that the mains frequency is maintained during feedback. For this reason, it is proposed that the processor generates at least one synchronisation signal for the electric vehicle coupled to the induction coil to synchronise the input voltage at the induction coil with a mains frequency at the grid connection point. The processor first determines the mains frequency and the zero crossings, so that the processor has knowledge of the electrical state of the grid. For this purpose the processor can, for example, also use units of the meter. According to the information on the mains frequency, it is advantageous to generate a synchronisation signal, which is preferably transmitted wirelessly to the electric vehicle. This makes it possible to generate an induction voltage in the electric vehicle synchronously with the mains frequency, so that the electrical current in the induction coil coupled to the electric vehicle is synchronous with the grid and adaptation within the charging station is no longer necessary. It should be mentioned that the synchronization signal is only an example and that other aspects described here can be inventive independently.

According to an embodiment, it is proposed that the process is set up to compare a measured value with a measured value received from the electric vehicle. In particular, a measured value may include current, voltage and/or frequency. Preferably, a measured value is also a combination of at least two individual measured values, for example the electrical power or the electrical energy. When feeding back, it is necessary that the fed back electrical energy is reimbursed to the owner of the electric vehicle. However, the power dissipation is considerable with induction transmission. For this reason, the electrical energy fed in at the grid connection point is lower than the electrical energy taken from the electrical energy storage of the electric vehicle. For billing purposes, however, it is necessary to first determine the electrical energy taken from the energy storage device of the electric vehicle. For this purpose it is necessary that a meter is installed in the electric vehicle which directly records which electrical energy has been transferred from the energy storage of the electric vehicle to the induction coil of the electric vehicle. However, the power loss cannot be at the expense of the energy supplier, so that the power loss on the transmission line must also be taken into account. The electrical energy fed into the grid connection point must therefore also be recorded at the charging station. There is a difference between the two recorded values, one in the vehicle and the other in the charging station, which is due to the electrical power loss on the path between the energy storage device of the electric vehicle and the meter in the charging station. This power dissipation is determined by comparing the measured values of the two measuring counters.

It can also happen that the electrical coupling between the electric vehicle or its induction coil and the charging station or its induction coil is unfavourable, for example due to poor positioning relative to each other. If a feedback process is then triggered in the electric vehicle, the energy may be taken from the energy storage but is not sufficiently absorbed via the induction coil of the charging station, or is not absorbed at all. This would lead to considerable power losses inside the electric vehicle and even damage to the electronics or the coil inside the electric vehicle. It must therefore be ensured that there is a sufficiently good inductive coupling between the two induction coils during a feedback process. To ensure this, the measured values recorded shall be used to determine whether there is sufficient electromagnetic coupling between the coil of the electric vehicle and the induction coil. This can be done, for example, by comparing the electrical powers in the electric vehicle and in the charging station. If the two measured values differ by a threshold value, this may indicate that the electromagnetic coupling is insufficient or not present at all. Then, for example, a feedback process in the electric vehicle could be interrupted. With the aid of the measured value received from the electric vehicle, it can be determined in the charging station whether the feedback of electrical energy is successful or not. If necessary, a signal, preferably wireless, can be transmitted from the charging station to the electric vehicle in order to signal that the inductive coupling is not sufficient to continue a feedback process. This process can then be interrupted.

According to an embodiment, it is proposed that an AC/AC converter is arranged to convert the voltage tapped at the induction coil into a voltage of the grid connection point. The output voltage at the induction coil depends on the winding ratio between the induction coil and the coil in the electric vehicle on the one hand and the voltage at the coil in the electric vehicle on the other hand. Usually, the voltage on the side of the electric vehicle will be 360 V, as this is currently a common voltage value for electric vehicles. However, the voltage may vary depending on the design of the energy storage inside the electric vehicle. If the windings on the induction coil and the coil of the electric vehicle are not dimensioned accordingly, the mains voltage required to feed the electrical energy into the grid is not applied to the induction coil. To make this possible, an AC/AC converter converts the tapped voltage into a voltage of the grid point. The voltage at the grid point is preferably greater than 360 V, in particular 370 V, for feedback power supply.

If no synchronisation of the input voltage at the induction coil with the mains frequency at the grid connection point is generated, especially if the synchronisation signal is omitted, it can also be inventive on its own that the AC/AC converter is set up to convert the frequency present at the induction coil into a frequency of the grid connection point. In this case, the synchronization signal can be used by the AC/AC converter alternatively or cumulatively to the electronics in the electric vehicle.

According to an embodiment it is proposed that the number of windings of the induction coil is such that a voltage transformed from the output voltage of the electric vehicle can be tapped at the induction coil. In particular, the number of windings of the coil in the charging station may deviate from the number of windings of the coil in the electric vehicle, preferably by more than 1% and in particular less than 10%. According to an embodiment, the ratio between the number of windings can be between 4:3.8 and 4:3.4.

The voltage can be transformed up or down depending on whether there are more or less windings on the charging station coil than on the electric vehicle coil.

According to an embodiment, it is proposed that, in addition to the induction coil, a second coil with a different number of windings from the induction coil is provided and that the induction coil is arranged to receive electrical power from the electric vehicle and that the second coil is arranged to deliver electrical power to the electric vehicle. Due to the different voltages which are necessary when electrical energy is taken from the power supply network or when electrical energy is fed into the power supply network, it may also be necessary to use different induction coils for receiving or feeding back power. For feedback power supply, the voltage level should be above the voltage of the electrical power supply network in order to enable feedback power supply. When receiving power from the grid in the energy storage of the electric vehicle, the voltage of the grid is usually applies. On the part of the energy storage, however, it is necessary to apply a defined DC voltage to the energy storage. In order to generate this as easily as possible in the electric vehicle, it may make sense to provide a second coil to the induction coil, which is used to receive electrical energy from the grid in the electric vehicle, whereas the induction coil is used exclusively for feedback power. In order to achieve different voltage levels, the different winding numbers of the two coils therefore make sense.

According to an embodiment, it is proposed that the induction coil and the second coil are encapsulated in a housing and connected to the meter via a supply line. This means that both feedback and supply can be implemented in a single housing using the two coils.

Another aspect is an electric vehicle with an energy storage. An energy storage is preferably a series and parallel connection of battery cells which are preferably connected in such a way that a DC voltage of 400 V is present in the electric vehicle. An induction coil can be connected to the energy storage via an inverter, which is arranged for inductive coupling with an induction coil of a charging station. Finally, the electric vehicle is equipped with a meter that can meter an electrical power flow from the energy storage to the induction coil. The meter can be constructed according to the meter of the charging station and meter electrical quantities such as voltage, current, frequency, phase position and/or the like. The meter is preferably located in the AC circuit of the electric vehicle, i.e. between the inverter and the induction coil. This is in particular relevant since the power flow can be measured more easily in an alternating current network than in a direct current network.

For mains synchronous feedback, it is proposed that an inverter is arranged between the energy storage and the induction coil, which generates an output voltage depending on a synchronisation signal received from a charging station. In particular, the frequency of the output voltage depends on the synchronization signal. However, it is also possible that the absolute value of output voltage can be dependent on the synchronisation signal, in particular to adapt the output voltage at the induction coil of the charging station to the voltage level of the grid.

As already explained, the meter is preferably located between the inverter and the induction coil.

According to an embodiment, it is proposed that the inverter includes a DC/AC converter. Preferably, the DC/AC converter can be such that a voltage between 400 and 370 V AC at a frequency between 48 and 51 Hz is applied on the output side.

It may also make sense for the inverter to include an AC/DC converter. When feeding electrical energy into the energy storage, for example, an alternating voltage can be applied from the induction coil, which must be converted into a direct voltage for the energy storage. In this case the AC/DC converter can be such that it receives an input voltage between 340 and 380 V and generates an output voltage between 380V and 400 V DC.

As explained above, the inverter is designed to convert both an AC input voltage from the induction coil to a DC voltage for the energy storage and a DC voltage from the energy storage to an AC output voltage for the induction coil. The input AC voltage is preferably smaller than the output AC voltage, whereby the DC voltage at the energy storage device is always the same. Thus the DC/AC converter has a different conversion ratio than the AC/DC converter within the inverter.

Another aspect is a system with a charging station described above and an electric vehicle described above.

### BRIEF DESCRIPTION OF THE DRAWING

In the following, the subject-matter is explained in more detail with reference to a drawing showing embodiments. The drawings show:

FIG. 1 shows a charging station, according to the subject-matter;

FIG. 2 shows an electric vehicle, according to the subject-matter.

### DETAILED DESCRIPTION

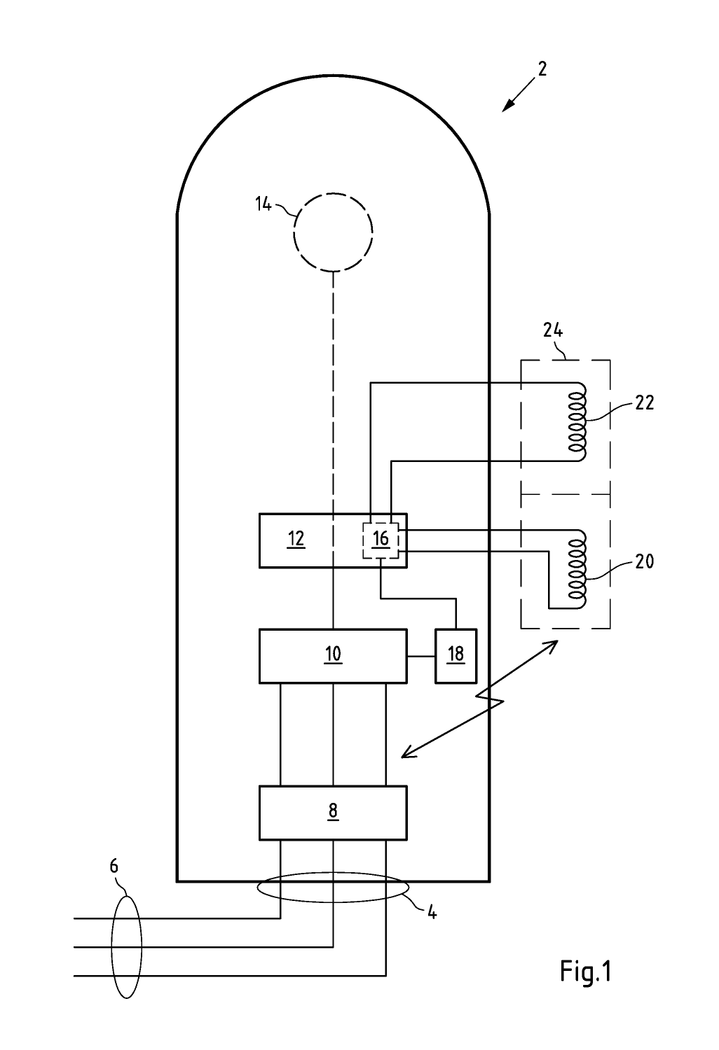

FIG. 1 shows a charging station 2 with a grid connection point 4 for a grid 6. A three-phase grid 6 is shown, but any other configuration is also useful. In the following, three phases are not always shown or required, so that the following description can be valid for each individual phase of a multi-phase energy supply network.

The charging station 2 has a disconnection device 8 at the grid connection point 4, for example in the form of a contactor, at each individual phase. Such a load break switch makes it possible to disconnect charging station 2 from the electrical power supply network 6 even under load. Starting from the disconnection device 8, a meter 10 is arranged in the charging station 2. The meter 10 meters in particular the voltage, the current and/or the phase angle, preferably on each individual phase. In addition, the meter 10 can meter a frequency of the grid 6.

Via charging electronics 12, in which a processor can be arranged, the meter 10 can, for example, be connected to a stationary charging point 14. This charging point 14 makes it possible, for example, to charge an electric vehicle via an electric line. This charging point 14 is optional.

A converter 16 can be arranged in the area of the charging electronics 12. The converter 16 is preferably an AC/AC converter, designed to convert an input voltage into an output voltage and preferably to set the frequency. Finally, the charging electronics 12 and the meter 10 are connected to a communication device 18.

Starting from converter 16, a first induction coil 20 can be provided. The induction coil 20 is arranged to be coupled with an induction coil of an electric vehicle shown below. On the one hand, the induction coil 20 can be used exclusively for feeding electrical energy back into the grid 6, but on the other hand it is also conceivable that the induction coil 20 is also arranged for feeding the electric vehicle from the energy supply network 6.

In the first case, when the induction coil 20 is used exclusively for feedback purposes, a further coil 22 can be provided, which can also be connected to the grid 6 via converter 16. Coil 22 can, for example, be used to supply an energy storage of an electric vehicle shown below. Induction coil 20 and coil 22 can be encapsulated in a common housing 24.

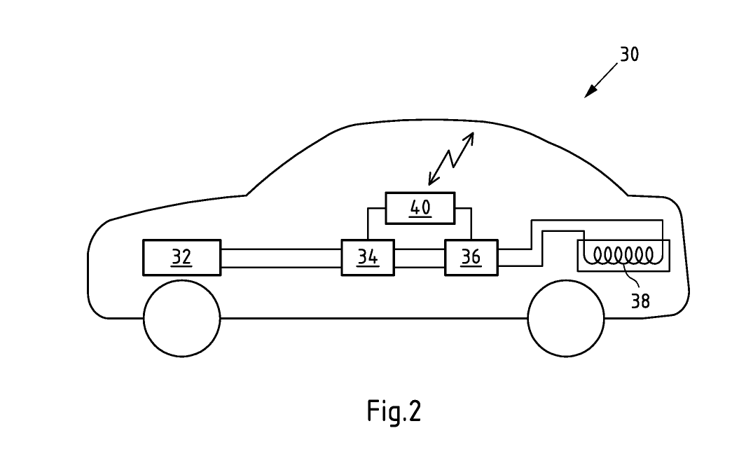

FIG. 2 shows an electric vehicle 30 whose power-train is at least partly powered by an energy storage 32. The energy storage 32 is connected to a meter 36 via a converter 34. The meter 36 preferably measures current, voltage as well as frequency and/or phase position between current and voltage. The meter 36 is connected to a coil 38. In addition, meter 36 and converters 34 are connected to a communication device 40.

The charging station 2 works with the electric vehicle 30 in the case of a feedback electrical energy from the energy storage 32 into the grid 6 as follows.

First, the electric vehicle 30 is moved into the vicinity of charging station 2 in such a way that an inductive coupling between coil 38 and induction coil 20 should be ensured. Subsequently, an activation signal is used to first activate converter 34 for DC/AC conversion of the DC voltage from the energy storage 32 into AC voltage. This alternating voltage flows via the meter 36 to the coil 38 and induces a magnetic field there.

This magnetic field should induce an output voltage in the charging station 2 in the induction coil 20. This is detected via the meter 10. The meter 10 and 36 exchange their respective measured values via the communication devices 18 and 40. Preferably in the charging electronics 12, the measured values of the two meters 10 and 36 are evaluated. If a power flow is reported by meter 36 and meter 10 determines that a received power flow is below a lower limit value or above a certain amount of the power flow in counter 36, it can be concluded that coil 38 is not sufficiently inductively coupled to coil 20. In this case, a cut-off signal is transmitted to the communication device 40 via the communication device 18 and the feed-back is interrupted on the vehicle side.

Otherwise, if the measured values of the meters 36 and 10 are equal such that their difference falls below a lower limit value, it can be concluded that there is sufficient inductive coupling between coil 38 and induction coil 20. In this case, the measured value of meter 10 is subtracted from the measured value of meter 36, resulting in the power loss over the distance between meter 36 and meter 10. Thus it can be determined which energy from the energy storage 32 was actually received in the meter 10 and was therefore fed into the grid 6.

Before the start of a feedback process, the frequency of the phases at the electrical power supply network 6 can be determined in the meter 10. A corresponding synchronization signal is transmitted from the meter 10 via the charging electronics 12 to the communication device 18 and from there to the communication device 40.

The communication device 40 then controls the converter 34 in such a way that the DC/AC conversion of the converter 34 is synchronous with the grid frequency. In this case, the AC voltage tapable at the induction coil 20 is synchronous with the grid frequency and no longer has to be converted regarding frequency via the converter 16. The converter 16 can be used to change the voltage level in order to feed electrical power into the power supply network 6. In particular, the converter 16 can be used to raise a voltage level so that feedback into the grid 6 is possible. For this purpose, the voltage can be increased above the mains voltage of the grid 6, for example by an amount of more than 1%, but preferably less than 5%.

In order to correctly adjust the output voltage on the induction coil 20, it is also proposed that the winding ratio between the winding of the induction coil 20 and the winding of coil 38 is set such that transformation takes place. The voltage at the energy storage 32 and therefore the alternating voltage at the output of the converter 34 can be 400 V AC, for example. The output voltage at the induction coil 20 should be 370 V, for example. In this case, the winding ratio between coil 38 and induction coil 20 is 4:3.7. This causes the voltage at meter 36 to be transformed down to a lower voltage at meter 10.

Coil 22 can be used for feeding electrical energy from the grid 6 into the electric vehicle 30. Coil 22 is supplied with AC voltage via converter 16 and an AC voltage induced from the generated magnetic field can be tapped in coil 38 or a separate coil not shown. Here, too, a transformation can take place in such a way that an input-side voltage of 360 VAC, for example, is converted into an output-side voltage of 400 V AC at the meter 36. Then only one AC/DC conversion is necessary in the converter 34.

With the help of the system shown, it is particularly easy to ensure a grid-compatible feedback of electrical energy from an energy storage in an electric vehicle 30 to an energy supply grid.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A charging station for electric vehicles, comprising:
an induction coil arranged for inductive coupling with an induction coil of an electric vehicle;
a grid connection point arranged for connection to an electrical grid;
a meter arranged to obtain an electrical power flow from the induction coil to the grids connection point; and
a processor;
wherein the processor generates at least one synchronization signal for the electric vehicle coupled to the induction coil for synchronization of the input voltage at the induction coil with a grid frequency at the grid connection point, the processor determining the mains frequency and zero crossings in order to generate the synchronization signal.

2. The charging station according to claim 1, wherein the processor is arranged to compare a measured value of the meter with a measured value received from the electric vehicle, in particular for obtaining an electrical power loss between the energy store and the meter and/or for detecting an electromagnetic coupling between a coil of the electric vehicle and the induction coil.

3. The charging station according to claim 1, wherein an AC/AC converter is arranged to convert the voltage tapped at the induction coil into a voltage of the grid connection point and/or wherein the AC/AC converter is arranged to convert the frequency present at the induction coil into a frequency of the grid connection point.

4. The charging station according to claim 1, wherein the number of windings of the induction coil is such that a voltage transformed from the output voltage of the electric vehicle can be tapped off at the induction coil.

5. The charging station according to claim 1, wherein in addition to the induction coil, a second coil with a different winding number than the induction coil is provided, and wherein the induction coil is arranged to receive electrical power from the electric vehicle, and wherein the second coil is arranged to output electrical power to the electric vehicle.

6. The charging station according to claim 1, wherein the induction coil and the second coil are encapsulated in a common housing and are connected to the meter via a supply line.

7. An electric vehicle, comprising:
an energy storage;
an induction coil arranged for inductive coupling with an induction coil of a charging station;
a meter arranged to meter an electrical power flow from the energy storage device to the induction coil;
a converter arranged between the energy store and the induction coil that generates an output voltage as a function of a synchronization signal received from a charging station,
wherein the synchronization signal is determined based on the mains frequency and zero crossings.

8. The electric vehicle according to claim 7, wherein the meter is arranged between the inverter and the induction coil.

9. The electric vehicle according to claim 7, wherein the inverter comprises a DC/AC converter.

10. The electric vehicle according to claim 1, wherein the converter is set up both for converting an AC input voltage from the induction coil into a DC voltage for the energy store and for converting a DC voltage from the energy store into an AC output voltage for the induction coil, in particular in such a way that the AC input voltage is lower than the AC output voltage.

11. A system comprising:
the charging station according to claim 1; and
an electric vehicle, comprising:
an energy storage;
an induction coil arranged for inductive coupling with an induction coil of a charging station;
a meter arranged to meter an electrical power flow from the energy storage device to the induction coil;
a converter arranged between the energy store and the induction coil that generates an output voltage as a function of a synchronization signal received from a charging station,
wherein the synchronization signal is determined based on the mains frequency and zero crossings.
